(19) United States
(12) Patent Application Publication
(10) Pub. No.: US 2009/0173721 A1
(43) Pub. Date: Jul. 9, 2009

(54) METHOD AND APPARATUS FOR WELDING ELECTRODE COLLECTORS AND TERMINALS OF ELECTRICAL STORAGE ELEMENT

(76) Inventors: Kouji Ueoka, Nara (JP); Teruhisa Miura, Kyoto (JP)

Correspondence Address: MCDERMOTT WILL & EMERY LLP, 600 13TH STREET, NW, WASHINGTON, DC, 20005-3096, US

(21) Appl. No.: 12/162,907

(22) PCT Filed: Mar. 1, 2007
(86) PCT No.: PCT/JP2007/053873

§ 371 Date: Jul. 31, 2008

(30) Foreign Application Priority Data
Mar. 10, 2006 (JP) 2006-065372

(51) Int. Cl. B23K 26/20; B23P 17/04

(52) U.S. Cl. 219/121.64; 29/592.1; 219/121.63

(57) ABSTRACT

In a welding method, at least one of a set of a first electrode collector and a first terminal and a set of second electrode collector and a second terminal is welded one another. At this time, a laser beam is irradiated to a portion to be welded, elastic waves generated due to the laser beam from the portion to be welded are detected, and the detected elastic waves are integrated to calculate an index corresponding to an amount of connection energy in order to check a welded state.

### TECHNICAL FIELD

The present invention relates to a method and a device for welding an electrode collector and a terminal of an electrical storage element such as an electric double layer capacitor or a battery used in various electronic apparatuses, and a method and an apparatus for manufacturing the electrical storage element using the welding method and device.

### BACKGROUND ART

FIG. 9 is a sectional view illustrating a conventional electric double layer capacitor. This double layer capacitor includes metal case 45 having a cylindrical shape with a bottom and capacitor element 41 housed in case 45. Capacitor element 41 is constructed in a manner of winding two electrodes with a separator therebetween. Each of the electrodes includes a collector and a polarizable electrode layer formed on the collector. Exposed portions 42A and 42B of the collector are arranged so as to protrude from capacitor element 41 in directions opposite to each other.

Protrusion 45A for positioning and fixing capacitor element 41 is formed on the inner bottom surface of case 45. Exposed portion 42B is joined to the inner bottom surface of case 45. On the other hand, protrusion 46A for positioning and fixing capacitor element 41 is also formed in sealing plate 46 joined to the end surface of capacitor element 41. Exposed portion 42A is joined to the inner surface of sealing plate 46. Such an electric double layer capacitor is disclosed in Patent Document 1, for example.

In the conventional electric double layer capacitor, exposed portions 42A and 42B are subjected to laser-welding to be electrically and mechanically joined to the inner surface of sealing plate 46 and the inner bottom surface of case 45, respectively. At this time, laser beams are irradiated from the outside toward the outer surfaces of sealing plate 46 and case 45, that is, toward the positions corresponding to exposed portions 42A and 42B of capacitor element 41 arranged inside case 45. For that reason, it is difficult to check a welding state. Only an appearance check operation for the welded portion is performed after the welding in order to check a welding condition.

However, such a check method is not sufficient. When irregularity in the welding state occurs and irregularity in a welding strength occurs, resistance may increase. Accordingly, in some cases, capacitor element 41 may be detached from case 45 or sealing plate 46.

Patent Document 1: Japanese Patent Unexamined Publication No. 2000-315632

### SUMMARY OF THE INVENTION

The present invention provides a welding method, a welding device, a manufacturing method, and a manufacturing apparatus capable of improving joining reliability by surely welding an electrical storage unit such as a capacitor element under an optimum condition using laser beams.

The welding method according to the invention is applicable to manufacture the electrical storage element which has a first electrode including a first electrode collector, a second electrode including a second electrode collector, a first terminal for connecting the first electrode to the outside, and a second terminal for connecting the second electrode to the outside. In the welding method according to the invention, at least one of a set of the first electrode collector and the first terminal and a set of the second electrode collector and the second terminal is welded one another. In the welding method according to the invention, laser beams are irradiated to a portion to be welded, elastic waves generated due to the laser beams from the portion to be welded are detected, and an index corresponding to an amount of connection energy is calculated by integrating the detected elastic waves. According to the welding method, the laser-welding is performed while checking the welding state of the portion subjected to the laser-welding is performed. In this way, the connection between the first electrode collector and the first terminal and the connection between the second electrode collector and/or the second terminal can be checked. Accordingly, it is possible to improve the joining reliability.

### BRIEF DESCRIPTION OF THE DRAWING

FIG. 1 is a sectional view illustrating a configuration of an electric double layer capacitor according to an embodiment of the invention.

FIG. 2A is a perspective view illustrating an unfolded capacitor element used in the electric double layer capacitor shown in FIG. 1.

FIG. 2B is a perspective view illustrating the capacitor element shown in FIG. 2A.

FIG. 3 is a diagram illustrating a relation between a method of manufacturing an electric double layer capacitor and a configuration of an apparatus for manufacturing the electric double layer capacitor according to the embodiment.

FIG. 4 is a diagram illustrating a configuration of a first welding unit of the manufacturing apparatus shown in FIG. 3.

FIG. 5A is a diagram illustrating the characteristic of elastic waves for detecting a melt-in state of a welded member when laser-welding is performed using the first welding unit shown in FIG. 4 and illustrating a case where the melt-in state is appropriate.

FIG. 5B is a diagram illustrating the characteristic of the elastic waves for detecting the melt-in state of the welded member when the laser-welding is performed using the first welding unit shown in FIG. 4 and illustrating a case where the output of laser beams is too large.

FIG. 5C is a diagram illustrating the characteristic of the elastic waves for detecting the melt-in state of the welded member when the laser-welding is performed using the first welding unit shown in FIG. 4 and illustrating a case where the melt-in state is not satisfactory.

FIG. 6 is a diagram illustrating a characteristic of an acoustic emission (AE) energy calculated from the area obtained by integrating the elastic waves shown in FIGS. 5A to 5C.

FIG. 7 is a diagram illustrating a characteristic of a centroid frequency calculated from the elastic waves shown in FIGS. 5A to 5C.

FIG. 8 is a perspective view illustrating a major part of the first welding unit shown in FIG. 4.

FIG. 9 is a sectional view illustrating the configuration of a conventional electric double layer capacitor.

### DETAILED DESCRIPTION OF PREFERRED EMBODIMENTS

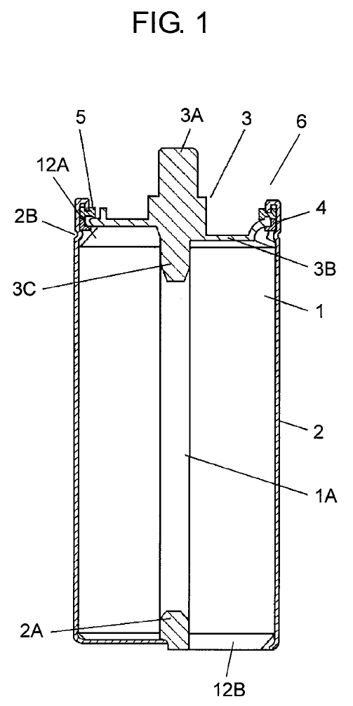

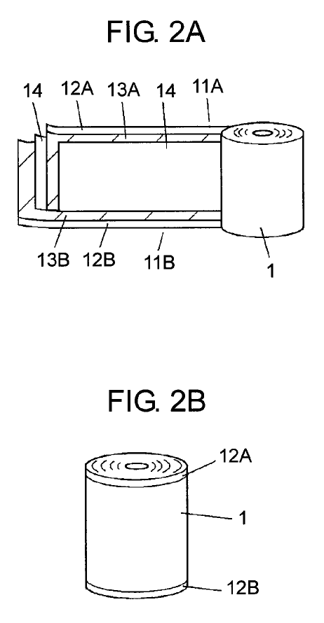

FIG. 1 is a sectional view illustrating an electric double layer capacitor, which is an electrical storage element, according to an embodiment of the invention. FIGS. 2A and 2B are a perspective view and an unfolded perspective view illustrating a capacitor element used in the electric double layer capacitor, respectively. Capacitor element 1, which is an electrical storage unit, includes first electrode (hereinafter, referred to as “electrode”) 11A, second electrode (hereinafter, referred to as “electrode”) 11B, and separator 14. Electrode 11A includes a first electrode collector and polarizable electrode layers 13A formed on the first electrode collector. The first electrode collector includes exposed portion 12A in which polarizable electrode layer 13A is not formed. That is, exposed portion 12A is a part of the first electrode collector. Likewise, electrode 11B includes a second electrode collector and polarizable electrode layers 13B formed on the second electrode collector. The second electrode collector includes exposed portion 12B in which polarizable electrode layer 13B is not formed. That is, exposed portion 12B is a part of the second electrode collector. Each of polarizable electrode layers 13A and 13B includes a mixture of activated carbon, an adhesion agent, and a conductive agent.

Capacitor element 1 is constructed in a manner of winding electrodes 11A and 11B with separator 14 interposed therebetween. At this time, electrodes 11A and 11B and separator 14 are disposed so that exposed portions 12A and 12B protrude in directions opposite to each other.

Capacitor element 1 is housed together with electrolyte solution (not shown) in case 2 having a cylindrical shape with a bottom. Case 2 is formed of metal such as aluminum. Protrusion 2A is formed integrally with case 2 in the center portion of the inner bottom surface of case 2. Protrusion 2A is inserted into hollow portion 1A of capacitor element 1. In this way, capacitor element 1 is positioned inside case 2. In addition, exposed portion 12B is mechanically and electrically joined to the inner bottom surface of case 2 by a laser welding processing.

On the other hand, terminal plate 3 is disposed at the opening of case 2. Terminal plate 3 is formed of metal such as aluminum. Protrusion 3C is formed integrally with terminal plate 3 in the center portion of the bottom surface of terminal plate 3. Protrusion 3C is inserted into hollow portion 1A of capacitor element 1. Positive terminal 3A for external connection is formed integrally with terminal plate 3 on the upper surface of terminal plate 3. Joining portion 3B for connecting with exposed portion 12A is formed in the inner surface of terminal plate 3. Exposed portion 12A is welded to the inner surface of joining portion 3B by irradiating laser beams to the outer surface of joining portion 3B to be mechanically and electrically joined thereto.

Draw-processed portion 2B having a V-shaped cross-section is formed near the opening of case 2. From the outside, draw-processed portion 2B presses the circumferential end surface of the upper portion of capacitor element 1 shown in the figure. Draw-processed portion 2B supports terminal plate 3 through insulating ring 4. That is, insulating ring 4 is disposed on the upper end of draw-processed portion 2B formed in case 2. In addition, insulating ring 4 is formed from a position between the inner surface of case 2 and the outer circumferential surface of terminal plate 3 to so as to be contacted to a part of the circumferential inner surface of terminal plate 3. Accordingly, insulating ring 4 maintains insulation between terminal plate 3 and case 2.

Sealing ring 5 is formed of insulating rubber. The opening of case 2 is processed so as to be curled with sealing ring 5 interposed in a state where sealing ring 5 is disposed in the circumference of the surface of terminal plate 3. This process is generally called a curling process. In this way, the inside of case 2 is sealed to complete electric double layer capacitor 6.

Positive terminal 3A connects electrode 11A to the outside and case 2 connects electrode 11B to the outside. That is, terminal plate 3 is a first terminal which functions as connecting electrode 11A as a first electrode to the outside. Case 2 is a second terminal which functions as connecting electrode 11B as a second electrode to the outside.

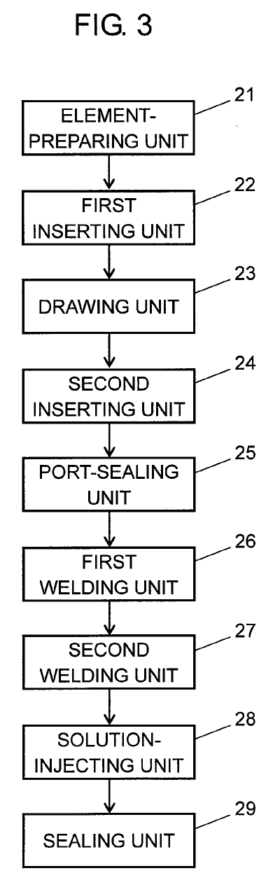

FIG. 3 is a diagram illustrating a relation between a method of manufacturing an electric double layer capacitor and a configuration of an apparatus for manufacturing the electric double layer capacitor according to this embodiment. The manufacturing apparatus includes element-preparing unit 21, first inserting unit 22, drawing unit 23, second inserting unit 24, port-sealing unit 25, first welding unit 26, second welding unit 27, solution-injecting unit 28, and sealing unit 29.

Element-preparing unit 21 prepares capacitor element 1 by inserting separator 14 between electrodes 11A and 11B and winding them. At this time, electrodes 11A and 11B are combined so as to expose exposed portions 12A and 12B in directions opposite to each other. First inserting unit 22 inserts capacitor element 1 into case 2. Drawing unit 23 subjects the vicinity of the opening of case 2 to a drawing process to form draw-processed portion 2B. Second inserting unit 24 sequentially inserts insulating ring 4, sealing ring 5, and terminal plate 3 into the opening of case 2. Port-sealing unit 25 subjects the vicinity of the opening of case 2 to the curling process to seal case 2 with terminal plate 3.

First welding unit 26 irradiates laser beams onto the outer surface (the upper surface) of joining portion 3B to connect terminal plate 3 to exposed portion 12A. Second welding unit 27 irradiates laser beams onto the outer bottom surface of case 2 to connect case 2 to exposed portion 12B. Solution-injecting unit 28 injects electrolyte solution into case 2 through a solution-injection hole (not shown) to impregnate the electrolyte solution into capacitor element 1. Sealing unit 29 inserts a sealing stopper such as a rubber member (not shown) or inserts a metal stopper into the solution injecting hole to seal the solution-injecting hole by welding terminal plate 3 and the metal stopper. This manufacturing method is disclosed in Japanese Patent Unexamined Publication No. 2006-210960, for example.

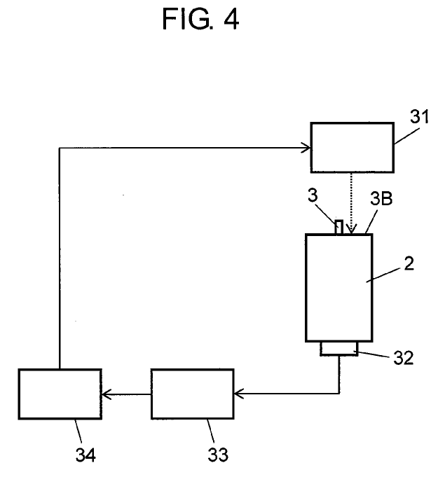

Next, the configurations of first welding unit 26 and second welding unit 27 will be described. FIG. 4 is a diagram illustrating the configuration of first welding unit 26. Since the configuration of second welding unit 27 is the same as that of first welding unit 26, only the configuration of first welding unit 26 will be described. In addition, one unit may function as first welding unit 26 and second welding unit 27. First welding unit 26 or second welding unit 27 is a welding device which welds at least one of a set of exposed portion 12A and terminal plate 3 and a set of exposed portion 12B and case 2 one another.

Laser-irradiating unit 31 irradiates laser beams to joining portion 3B to be welded. Sensor 32 detects elastic waves generated from joining portion 3B due to the laser beams. Calculator 33 calculates acoustic emission (AE) energy by integrating the elastic waves detected by sensor 32. Controller 34 controls the output of laser-irradiating unit 31 on the basis of the AE energy calculated by calculator 33. In sensor 32, there is used a piezoelectric element which employs a ferroelectric oxide having a perovskite crystal structure, such as lead zirconate titanate.

Generally, an elastic wave containing an ultrasonic wave caused due to minute movement of the inside is generated when a structural material is transformed or destroyed. Such a phenomenon or the wave is called the AE. That is, the AE refers to a phenomenon in which when metal or the like is subjected to plastic deformation or is destroyed, elastic waves are emitted from the portion subjected to the plastic deformation or destroyed. The AE is also generated due to very minute movement in a material. Accordingly, by using the AE, it is possible to detect minute movement appearing as scratches inside a structure in real time. According to this embodiment, the AE energy is used as an index corresponding to an amount of connection energy.

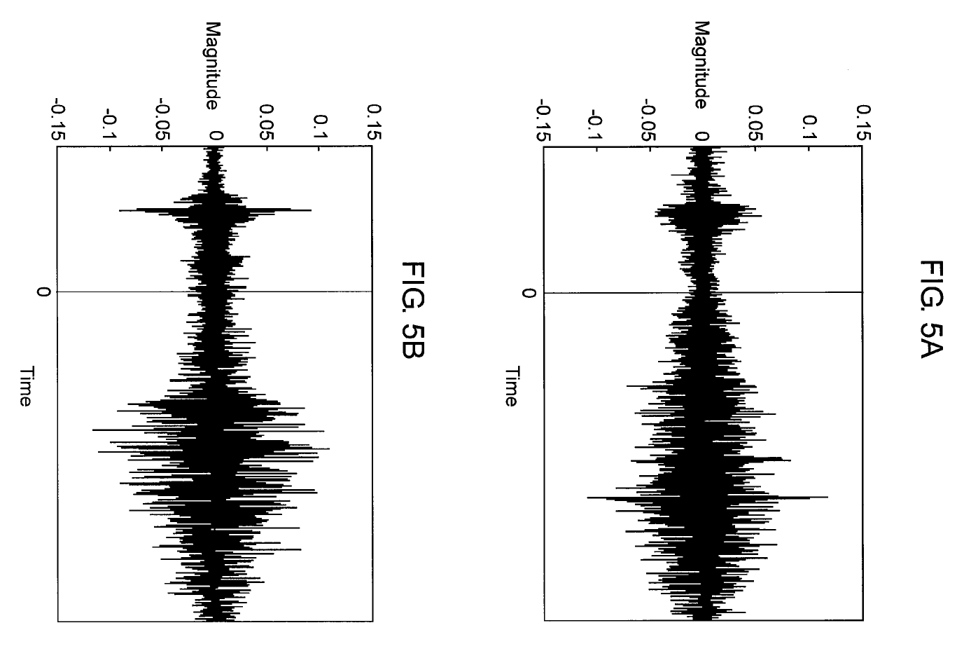

FIGS. 5A to 5C are diagrams illustrating the elastic waves which reflect a melt-in state of a member subjected to laser-welding and are simultaneously detected by sensor 32 at the time of welding. A vertical axis represents the magnitude of elastic waves and a horizontal axis represents time. A right side of 0 in the horizontal axis shows an effective component of the elastic waves generated by the irradiation of the laser beams. FIG. 5A shows a case where the connection between terminal plate 3 and exposed portion 12A is good. FIG. 5B shows a case where a hole occurs in joining portion 3B since the amount of connection energy is too large. FIG. 5C shows a case where a welding strength between terminal plate 3 and exposed portion 12A is small.

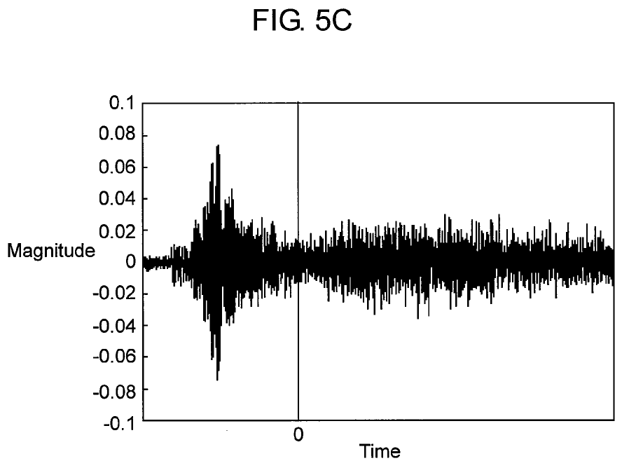

FIG. 6 is a diagram illustrating characteristics of the AE energies obtained from the area by integrating the elastic waves shown in FIGS. 5A to 5C. In addition, FIG. 6 shows data of the AE energies when the irradiating of the laser beams is performed plural times. Points A, B and C in a horizontal axis are based on cases where data is obtained in FIGS. 5A, 5B, and 5C, respectively.

As apparent from FIG. 6, it can be understood that the AE energy is too large in the case B where a hole occurs in joining portion 3B, compared to the case A where the amount of connection energy is optimized. On the other hand, it can be understood that the AE energy is too small in the case C where the welding strength is small, compared to the case A. In this way, by calculating the AE energy, it is possible to determine whether or not the welding strength or the amount of connection energy of terminal plate 3 and exposed portion 12A is appropriate. Accordingly, by feedbacking the AE energy calculated by calculator 33 to controller 34 and adjusting the output of laser-irradiating unit 31, it is possible to adjust the welding strength in an appropriate range. That is, it is preferable that the feedbacking is performed so as to adjust the output of the laser welding in accordance with the amount of AE energy calculated in this manner. This feedbacking contributes to more optimum laser welding, thereby manufacturing electric double layer capacitor 6 with reliable joining.

Alternatively, by determining whether or not the welding is good using the calculated AE energies, it is possible to exclude inferior products. For example, by providing a display device such as a liquid crystal display in calculator 33, the welding strength for each shot of laser-irradiating can be displayed how the welding strength is with respect to the appropriate range. In this case, controller 34 may not be provided.

Factors other than the laser output may cause welding failure. For example, if the position of draw-processed portion 2B is not appropriate or joining portion 3B and exposed portion 12A are spaced from each other, the welding failure may be caused. In this case, whether or not the welding is good is determined from the calculated AE energy, and a resolution of the cause is performed. Even in this case, controller 34 may not be provided.

When the entire portions subjected to the welding process are good is performed or not, all the amount of connection energies calculated at the time of performing the laser-irradiating plural times may not be within the appropriate range of the AE energy. That is, when the laser-irradiating is performed plural times, there occurs no problem even though the AE energies are smaller than the appropriate range several times as long as mechanical and electrical connection between terminal plate 3 and exposed portion 12A is satisfactory in consideration of the usage of electric double layer capacitor 6. However, even though the AE energy is larger than the appropriate range just one time, there is a possibility that a hole occurs in terminal plate 3. Accordingly, it is necessary to additionally determine whether or not the welded portion is good with the naked eye or the like method.

If a foreign substance such as a material of polarizable electrode layer 13A is interposed between joining portion 3B and exposed portion 12A at the time of the laser-welding, a hole may occur in terminal plate 3 regardless of the output of the laser beams. Moreover, the amount of connection energy calculated from the elastic waves generated when the laser beams are irradiated to such a portion is small, even when the output of the laser beams is too large. For that reason, if the foreign substance is interposed between joining portion 3B and exposed portion 12A, the welding strength cannot be determined on the basis of the amount of connection energy.

In a case D shown in FIG. 6, the foreign substance is interposed between joining portion 3B and exposed portion 12A as described above, and the output of the laser beams is the same as that in the case B. In this case, the result that the AE energies almost equal to those in the case A are detected is included as circled by the solid lines.

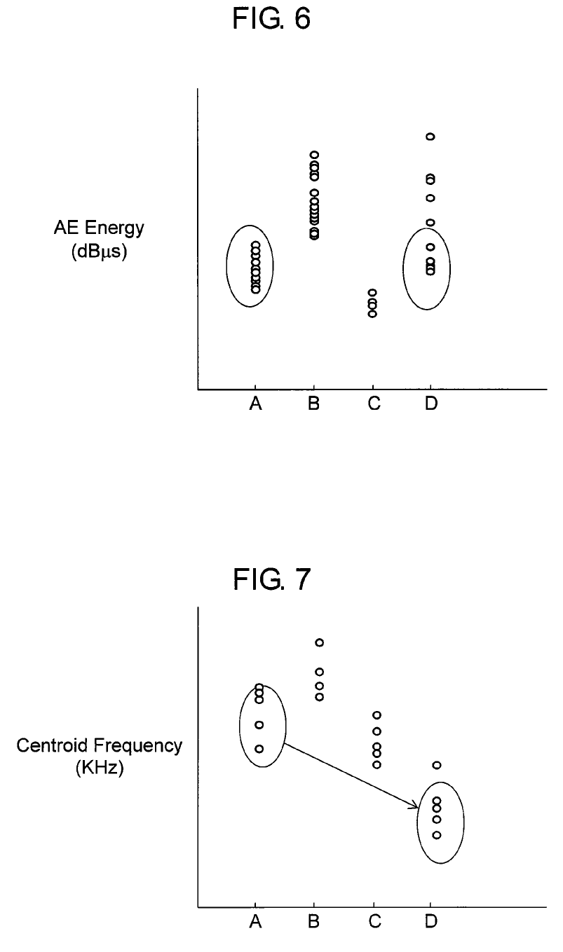

To overcome the problem, it is preferable that calculator 33 integrates the number of occurrences of the frequency included in the elastic waves detected by sensor 32 and calculates a centroid frequency corresponding to an average value of the occurrence frequency. FIG. 7 is a diagram illustrating centroid frequencies calculated in the cases A, B, C, and D shown in FIG. 6. The result of the case D shows data at the time of irradiating the laser beams to the portion where the foreign substance is interposed between joining portion 3B and exposed portion 12A. In this way, by calculating the centroid frequency, it is possible to distinguish the case A and the case D which cannot be distinguished on the basis of only the AE energies. However, as apparent from FIG. 7, the case A and the case B cannot be clearly distinguished on the basis of only the centroid frequencies. For that reason, it is preferable that the welding strength is determined on the basis of the calculation results of the AE energy and the centroid frequency. Meanwhile, a calculator for calculating the centroid frequency may be provided independently of calculator 33 for calculating the AE energy.

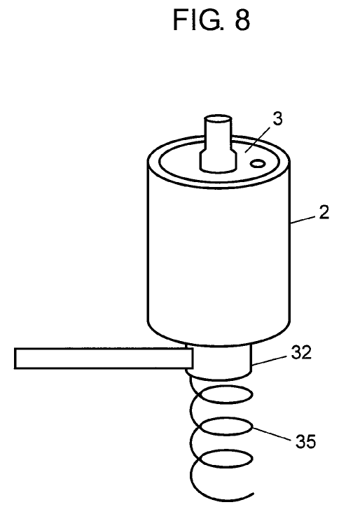

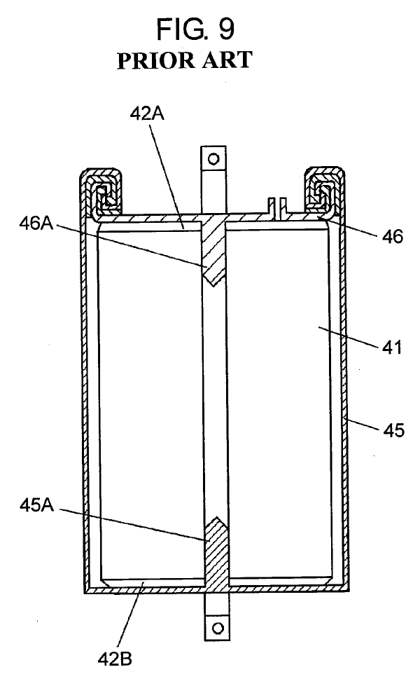

Next, an exemplary configuration in the vicinity of sensor 32 will be described. FIG. 8 is a perspective view illustrating major members of first welding unit 26. In the configuration, there is provided a spring as pressing member 35 for pressing sensor 32 against case 2. With such a configuration, sensor 32 can surely detect the elastic waves generated in the laser-welding. Alternatively, the spring may press sensor 32 against terminal plate 3 instead of case 2. That is, pressing member 35 presses sensor 32 against the outer surface of electric double layer capacitor 6.

Pressing member 35 may be an elastic member such as a rubber member, a servomotor, an arm mechanism, an air cylinder, or the like as well as a spring. Moreover, since sensor 32 is relatively pressed against the outer surface of electric double layer capacitor 6, pressing member 35 may press electric double layer capacitor 6 against sensor 32.

It is preferable that calculator 33 calculates the AE energy on the basis of only the elastic waves detected while laser-irradiating unit 31 irradiates the laser beams. As shown in FIGS. 5A to 5C, sensor 32 detects elastic waves at other time as well as the time of the laser-welding. The elastic waves are caused due to vibration at the time of moving electric double layer capacitor 6 or due to vibration of another device delivered through a jig (not shown) for fixing case 2, for example. Such elastic waves are noises. Accordingly, an error in determination of the welding strength may occurs when the AE energy is calculated containing the noises. Even though the magnitude of the noises is small, an amount of data to be processed in calculator 33 increases, thereby affecting its processing capacity. Accordingly, it is preferable that calculator 33 calculates the AE energy on the basis of only the elastic waves detected while laser-irradiating unit 31 irradiates the laser beams.

To perform the calculating, signals for indicating the start and end of laser oscillation from laser-irradiating unit 31 are extracted, and timing of signal acquisition in calculator 33 is controlled using the signals as triggers. Alternatively, a relay member may be provided between sensor 32 and calculator 33 and the relay member may be turned on and off using the signals for indicating the start and end of the laser oscillation from laser-irradiating unit 31. It is preferable that the above process is performed in the same manner as that at the time of detecting the centroid frequency.

According to the above-described embodiment, the welding method, the welding device, the manufacturing method using the welding device, and the manufacturing apparatus are capable of performing the laser welding while checking the welding state of the welded portion subjected to the laser welding is performed. Accordingly, it is possible to reliably weld capacitor element 1 and case 2 or capacitor element 1 and terminal plate 3 under an optimum condition using laser beams. As a result, it is possible to improve joining reliability and reduce cost by considerably decreasing welding failure. In particular, in this embodiment, the laser beams are irradiated toward terminal plate 3 from the outside of electric double layer capacitor 6. The outside of terminal plate 3 is opposite to exposed portion 12A to be welded. According to the above-described embodiment, the welding method, the welding device, the manufacturing method using the welding device, and the manufacturing apparatus are very effective in a configuration where it is difficult to check the welding strength since the welded portions cannot be seen with the naked eye.

In this embodiment, the configuration shown in FIG. 4 is applied to both first welding unit 26 and second welding unit 27, but the configuration may be applied to only one thereof.

In this embodiment, the electric double layer capacitor has been described as the electrical storage element. However, the invention is not limited thereto. For example, the welding method and the manufacturing method according to the invention may be applied to an electrochemical element such as an electrolytic capacitor or a battery, or an electrical storage element such as a film capacitor.

### INDUSTRIAL APPLICABILITY

According to the invention, a welding method, a welding device, a manufacturing method using the welding device, and a manufacturing apparatus are capable of welding a first electrode collector and a first terminal or a second electrode collector and a second terminal using laser beams. At this time, the welding state can be checked. Moreover, it is possible to improve joining reliability by a reliably welding under an optimum condition. The invention is effective in manufacture of an electric double layer capacitor, a battery and the like used in various electronic apparatuses.

1. A welding method for welding at least one of a set of a first electrode collector and a first terminal and a set of a second electrode collector and a second terminal one another, of an electrical storage element which has a first electrode including the first electrode collector, a second electrode including the second electrode collector, the first terminal for connecting the first electrode to outside, and the second terminal for connecting the second electrode to the outside, the welding method comprising:
irradiating a laser beam to a portion to be welded;
detecting elastic waves generated due to the laser beam from the portion to be welded; and
calculating an index corresponding to an amount of connection energy by integrating the detected elastic waves.

2. The welding method according to claim 1, further comprising adjusting an output of the laser beam based on the index when irradiating the laser beam.

3. The welding method according to claim 1, further comprising integrating number of occurrences of a frequency included in the detected elastic waves so as to calculate a centroid frequency corresponding to an average value of the number of occurrences.

4. The welding method according to claim 1, wherein the index is calculated based on only the elastic waves detected during irradiation of the laser beam.

5. The welding method according to claim 1, wherein the laser beam is irradiated to at least one of the first terminal and the second terminal from outside of the electrical storage element which is opposite to one of the first electrode collector and the second electrode collector to be welded.

6. A manufacturing method of an electrical storage element which includes a first electrode including a first electrode collector, a second electrode including a second electrode collector, a first terminal for connecting the first electrode to outside, and a second terminal for connecting the second electrode to the outside, the method comprising:
A) combining the first electrode and the second electrode so as to expose the first electrode collector and the second electrode collector to sides opposite to each other so as to prepare an electrical storage unit;
B) welding the first electrode collector exposed from the electrical storage unit and the first terminal which makes connection to the outside; and
C) welding the second electrode collector exposed from the electrical storage unit and the second terminal which makes connection to the outside,
wherein at least one of the step “B” and the step “C” includes:
irradiating a laser beam to a portion to be welded;
detecting elastic waves generated due to the laser beam from the portion to be welded; and
integrating the detected elastic waves to calculate an index corresponding to an amount of connection energy.

7. A welding device capable of welding at least one of a set of a first electrode collector and a first terminal and a set of a second electrode collector and a second terminal one another, of an electrical storage element which has a first electrode including the first electrode collector, a second electrode including the second electrode collector, the first terminal for connecting the first electrode to outside, and a second terminal for connecting the second electrode to the outside, the welding device comprising:
a laser-irradiating unit configured to irradiate a laser beam to a portion to be welded;
a sensor capable of detecting elastic waves generated due to the laser beam from the portion to be welded; and
a calculator configured to calculate an index corresponding to an amount of connection energy by integrating the elastic waves detected by the sensor.

8. The welding device according to claim 7, further comprising a controller configured to control an output of the laser-irradiating unit based on the index calculated by the calculator.

9. The welding device according to claim 7, wherein the calculator additionally integrates number of occurrences of a frequency included in the detected elastic waves so as to calculate a centroid frequency corresponding to an average value of the number of occurrences.

10. The welding device according to claim 7, wherein the calculator calculates the index based on only the elastic waves detected while the laser-irradiating unit irradiates the laser beam.

11. The welding device according to claim 7, wherein the laser-irradiating unit irradiates the laser beam to at least one of the first terminal and the second terminal from the outside of the electrical storage element, which is opposite to one of the first electrode collector and the second electrode collector to be welded.

12. The welding device according to claim 7, further comprising a pressing unit configured to press the sensor against at least one of the first terminal and the second terminal of the electrical storage element.

13. An apparatus for manufacturing an electrical storage element which includes a first electrode including a first electrode collector, a second electrode including a second electrode collector, a first terminal for connecting the first electrode to outside, and a second terminal for connecting the second electrode to the outside, the apparatus comprising:
an element-preparing unit configured to combine the first electrode and the second electrode so as to expose the first electrode collector and the second electrode collector to sides opposite each other, to prepare a electrical storage unit;
a first welding unit configured to weld the first electrode exposed from the electrical storage unit and the first terminal which makes connection to the outside; and
a second welding unit configured to weld the second electrode exposed from the electrical storage unit and the second terminal which makes connection to the outside,
wherein at least one of the first welding unit and the second welding unit includes:
a laser-irradiating unit configured to irradiate a laser beam to a portion to be welded;
a sensor capable of detecting elastic waves generated due to the laser beam from the portion to be welded; and
a calculator configured to calculate an index corresponding to an amount of connection energy by integrating the elastic waves detected by the sensor.
